(19) United States
(12) Patent Application Publication
(10) Pub. No.: US 2004/0169149 A1
(43) Pub. Date: Sep. 2, 2004

(54) Imaging plate with means for indicating improper exposure or orientation

(76) Inventors: Edgar Alzner, Garden City, NY (US); Frederick R. Fischer, Farmingdale, NY (US)

Correspondence Address: CLIFFORD G. FRAYNE, Suite 7A, 136 Drum Point Road, Brick, NJ, 08723, US

(21) Appl. No.: 10/376,940

(22) Filed: Feb. 28, 2003

(51) Int. Cl. G03B 42/08

(52) U.S. Cl. 250/484.4

(57) ABSTRACT

A photo-stimulable phosphor imaging plate having a non-toxic radio-opaque symbol, pattern or indicia formed on one surface, the so called rear surface, which would become visually apparent in an image if the imaging plate was exposed from the wrong side, thereby eliminating confusion that the image is from the opposing side of the face, and a light-opaque, color contrasting, asymmetric symbol or indicia on the front surface eliminating the confusion of a flipped image, and a correspondingly back to back located color contrasting identical asymmetric symbol on the opposite rear surface of the plate, emulating the raised orientation dot of standard intraoral films.

### BACKGROUND OF THE INVENTION

1. Field of the Invention

The present invention relates to imaging plates, and more particular, dental imaging plates with a means to indicate to the dental technician that the imaging plate was exposed from the improper or wrong side and/or has been flipped over.

2. Description of the Prior Art

In dental technology, intraoral x-ray images have traditionally been obtained by placing x-ray film in the patient's oral cavity behind the tooth or teeth to be imaged. The film must be oriented correctly to optimize the region of the mouth that will be contained in the film's image. In processing the film to make the latent image visible, films are processed either manually or by automatic film processors that use developer, fixer, wash and drying phases for the complete process. Since the images are contained within the film and are viewed by looking through the film, the angular orientation of the film within the processor is not critical.

Dental technology is now in the age of digital imaging. One method of digital imaging utilizes the photo-stimulable phosphor (PSP) imaging plate. In the PSP imaging plate, the latent image is contained within the imaging plate and this latent image has to be “read” opto-mechanically by means of a scanner. Present PSP imaging plates have no means to indicate to the dental technician that the plate was exposed from the wrong side. The problem this presents is that it could lead to confusion in that in reading the image, it could be confused with the opposite side of the face (right to left, or left to right). This confusion or error may be infrequent with a dentist or dental technician who has treated the individual over the course of time, such that their familiarity would lead them to realize what had happened. However, with this imaging technology becoming more and more important and popular in the dental arts, and the mobility of individuals to move and change jobs frequently, dental records are transferred on a rather common and regular basis. Still further, dental records are oftentimes required by insurance companies or law enforcement agencies and these types of individuals are certainly not familiar with an individual's dental history, nor do they have the prowess to recognize the problem set forth herein.

It would therefore be of an aid to the dental technician to have some form of indicia or symbol that would appear and be indicative of the fact that the photo-stimulable phosphor imaging plate had been exposed from the wrong side, or has been flipped over, and thus still be useable to provide a diagnostic image.

### OBJECTS OF THE INVENTION

An object of the present invention is to provide for a novel imaging plate that incorporates an indicia or symbol which would become visually apparent if the imaging plate was exposed from the improper or wrong side, or flipped over, and emulate all features of the raised dot present on standard intraoral X-ray films.

### SUMMARY OF THE INVENTION

A photo-stimulable phosphor imaging plate having a radioopaque symbol, pattern or indicia formed on one surface, the so called rear surface, which would become visually apparent if the imaging plate was exposed from the wrong side, and also not give a false indication of the imaging plate being exposed from the wrong side, thereby eliminating confusion that the image is from the opposing side of the face, and a light opaque asymmetric symbol on the front surface eliminating the confusion of a flipped image, yet still allow the derived image to be used for diagnostic purposes, and a correspondingly located identical asymmetric symbol on the rear surface of the plate to fulfill the second feature of the raised orientation dot of intraoral film.

### BRIEF DESCRIPTION OF THE DRAWINGS

These and other objects of the present invention will become evident particularly when taken in light of the following illustrations wherein:

FIG. 1 is a front surface view of an exposed imaging plate of the present invention;

FIG. 2 is a rear surface view of an exposed imaging plate of the present invention.

### DETAILED DESCRIPTION OF THE DRAWINGS

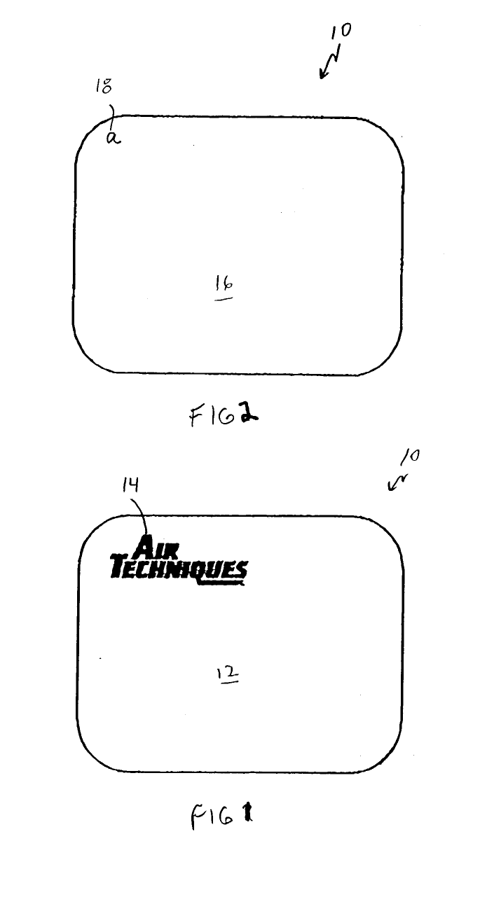

FIG. 1 is a front surface view of an imaging plate 10 of the present invention and FIG. 2 is a rear surface view of an imaging plate 10 of the present invention. The imaging plate 10 stores a latent image in a layer of photo-stimulable phosphor. The exposed plate is read opto-mechanically by a scanner with the image being digitally converted. This allows the imaging plates 10 to be erased and reused.

If the imaging plate 10 were to be exposed to the x-ray with the wrong side (rear surface) towards the x-ray, the resulting image could be confused as coming from the opposite side of the face (right to left or left to right). It would therefore aid the technician if there were some form of indicia, pattern or symbol which would alert the dental technician that the plate was exposed from the wrong side (rear side).

This is accomplished in the present invention with the presence of a thin coating or layer of non-toxic, radio-opaque material, such as molybdenum foil, molybdenum powdered paint, etc., in some form of distinguishable pattern, symbol or indicia on the rear surface 12 of FIG. 2. This symbol, pattern or indicia would become visible if the imaging plate were exposed from the wrong side and would not be visible due to back scattering, or similar effect, as has been observed with some lead foils and other radioopaque materials, when exposed from the correct side. In the example illustrated in FIG. 2, the radio-opaque indicia is a round dot 14, sufficiently large to be visible, but not so large that the diagnostic information is obscured.

The front surface 16 of the imaging plate 10 in one of its corners, such as its lower right hand corner, would have an asymmetrical character 18 such as a lower case “A”, namely “a”, formed of light opaque material. The properly oriented character “a” would be visible in the scanned image, but would appear as a mirror image if the image were flipped over. The flipped asymmetrical “a” would be an indication of the image having been flipped over within the imaging software after the image is read and acquired. The asymmetrical “a” is used herein as an example, however, any asymmetrical symbol, pattern or indicia would be suitable. This normal view of the displayed X-ray image, with the asymmetrical character as it appears on the front surface of the plate, corresponds to a dental intraoral image as if viewing the teeth from the outside of the mouth, which, except for some military installations, is the common way of viewing intraoral X-ray images. A replica of the asymmetric character 28 is printed on the rear side of the plate directly behind the location where the asymmetric character is located on the front side of the plate, so that this character on the two sides of the plate identifies the same corner. This character on both sides of the plate in the same corner serves the same function as the raised orientation dot found on existing standard intraoral X-ray films.

This application of the radio-opaque indicia on the rear surface of the plate provides for a fail safe system to alert the dental technician that an error has been made in exposure and that a re-exposure using a freshly erased imaging plate may be required if the patient data base system cannot indicate that the image plate was exposed from the wrong side, and the appearance of the backward facing asymmetric character on the front provides a fail safe system to alert the dental technician that an image has been flipped over. In the former case, if the image can be salvaged by proper annotation in the patient data base, additional X-ray exposure to the patient is thereby avoided, providing a health benefit to the patient.

While the present invention has been described with respect to the exemplary embodiments thereof, it will be recognized by those of ordinary skill in the art that many modifications or changes can be achieved without departing from the spirit and scope of the invention. Therefore it is manifestly intended that the invention be limited only by the scope of the claims and the equivalence thereof.

We claim:

1. A photo-stimulable phosphor imaging plate having means for indicating improper exposure or orientation after exposure or scanning said means comprising:
a photo-stimulable phosphor imaging plate having a first front surface and a second, rear surface;
a radio-opaque indicia formed on said second rear surface; and
a light-opaque asymmetrical indicia formed on said first front surface and an identical indicia formed and correspondingly located on said second rear surface.

2. The photo-stimulable phosphor imaging plate having means for indicating improper exposure or orientation in accordance with claim 1 wherein appearance of said radio-opaque indicia in a derived image after said exposure and scanning said image plate indicates improper orientation of said imaging plate at exposure.

3. A photo-stimulable phosphor imaging plate having means for indicating improper exposure or orientation in accordance with claim 1 wherein appearance of identifiable, asymmetrical indicia in a derived image after said exposure and scanning said imaging plate indicates proper orientation of said imaging plate.

4. A photo-stimulable phosphor imaging plate having means for indicating improper exposure or orientation in accordance with claim 3 wherein appearance of mirror image of said asymmetrical indicia in said derived image after exposure and scanning said imaging plate indicates flipping of said image.

5. A photo-stimulable phosphor imaging plate having means for indicating improper exposure or orientation in accordance with claim 1 wherein said radio-opaque indicia is formed by application of molybdenum foil or the like.

6. A photo-stimulable phosphor imaging plate having means for indicating improper exposure or orientation in accordance with claim 5 wherein said radio-opaque indicia is formed by application of molybdenum foil or the like, which does not give false back scattering images of itself.

7. A photo-stimulable phosphor imaging plate having means for indicating improper exposure or orientation in accordance with claim 1 wherein said radio-opaque indicia is formed by application of molybdenum powdered paint or the like.

8. A photo-stimulable phosphor imaging plate having means for indicating improper exposure or orientation in accordance with claim 5 wherein said radio-opaque indicia is formed by application of molybdenum powdered paint or the like, which does not give false back scattering images of itself.

9. A photo-stimulable phosphor imaging plate having means for indicating improper flipping orientation in accordance with claim 1 wherein said light-opaque asymmetric indicia is formed by application of light-opaque color contrasting point, such as black on white on the front side and white on black on the rear side or the like.

10. A photo-stimulable phosphor imaging plate having means for indicating improper flipping orientation in accordance with claim 9 wherein said light-opaque asymmetric indicia are located on both sides of said image plate in back to back corresponding locations.

11. A photo-stimulable phosphor imaging plate having means for indicating improper flipping orientation in accordance with claim 9 wherein said light-opaque asymmetric indicia are located in a corner of said image plate.
